(19) United States
(12) Patent Application Publication
(10) Pub. No.: US 2006/0194489 A1
(43) Pub. Date: Aug. 31, 2006

(54) FUEL CELL GAS DIFFUSION LAYER COATING PROCESS AND TREATED ARTICLE

(75) Inventors: John Charles Clark, White Bear Lake, MN (US); Joseph William Frisk, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/382,210

(22) Filed: May 8, 2006

Related U.S. Application Data
(63) Continuation of application No. 09/997,082, filed on Nov. 28, 2001, now abandoned.

(51) Int. Cl. B32B 27/04; B32B 5/02; B32B 27/12

(52) U.S. Cl. 442/82; 442/60; 442/79; 442/189; 442/334; 204/471; 204/492; 423/447.2

(57) ABSTRACT

A method is provided for making a hydrophobic carbon fiber construction, such as a fuel cell gas diffusion layer, by electrophoretic deposition of a highly fluorinated polymer, which may be followed by sintering of the fluoropolymer. A hydrophobic carbon fiber construction is provided, such as a fuel cell gas diffusion layer, which is coated with a monolayer of particles of a highly fluorinated polymer, which may be sintered.

This is a continuation of application Ser. No. 09/997,082, filed Nov. 28, 2001.

### FIELD OF THE INVENTION

This invention relates to a method of making a hydrophobic carbon fiber construction such as a fuel cell gas diffusion layer by electrophoretic deposition of a highly fluorinated polymer which may be followed by sintering of the fluoropolymer. This invention additionally relates to a hydrophobic carbon fiber construction coated with a monolayer of particles of a highly fluorinated polymer, which may be sintered.

### BACKGROUND OF THE INVENTION

Watanabe, “Improvement of the Performance and Durability of Anode for Direct Methanol Fuel Cells,” Proceedings of the Workshop on Direct Methanol-Air Fuel Cells, pp. 24-36 (1992), discloses a method of wet-proofing which involves coating carbon black with polyethylene out of a polyethylene latex, perfluorinating the polyenthylene in situ on the surface of the carbon black, and coating a gas diffusion layer with the hydrophobic carbon black.

U.S. Pat. No. 6,080,504 discloses a method of electrodeposition of catalytic metal on a substrate to form a gas diffusion electrode using a pulsed electric current.

U.S. Pat. Nos. 5,298,348 and 5,389,471 disclose a seperator for an alkaline battery system.

U.S. Pat. No. 6,083,638 discloses a fuel cell system that includes a current collector that includes hydrophilic materials and can also include hydrophobic materials. The current collector may be made of fibers such as carbon, glass or resin fibers. The hydrophilic material or bulking agent may be particles of materials such as carbon powder, metal powder, glass powder, ceramic powder, silica gel, zeolite or non-fluorinated resin. The hydrophobic material or bulking agent may be particles of materials such as fluorinated resin. (see, '638 FIG. 10).

U.S. Pat. No. 5,998,058 discloses an electrode backing layer for a polymer electrolyte membrane fuel cell formed from a carbon fiber substrate treated so as to contain both “hydrophilic” and “hydrophobic” pores. The reference describes a method of making pores more hydrophilic by immersion in a solution of tin tetrachloride pentahydrate followed by immersion in ammonia.

U.S. Pat. No. 6,024,848 discloses a porous support plate for an electrochemical cell which includes a contact bilayer adjacent to an electrode including a hydrophobic and a hydrophilic phase. The reference discloses a hydrophilic phase comprised of a mixture of carbon black and a proton exchange resin.

### SUMMARY OF THE INVENTION

Briefly, the present invention provides a method of making a hydrophobic carbon fiber construction such as a fuel cell gas diffusion layer comprising the steps of: a) immersing a carbon fiber construction in an aqueous dispersion of a highly fluorinated polymer, typically a perfluorinated polymer; b) contacting the dispersion with a counterelectrode; and c) electrophoretically depositing the highly fluorinated polymer onto the carbon fiber construction by applying electric current between the carbon fiber construction and the counterelectrode. Typically the carbon fiber construction is the anode and the counterelectrode is the cathode. Typically a voltage of greater than 6 volts is applied. Typically the step of electrophoretically depositing the highly fluorinated polymer can be accomplished in 30 minutes or less, more typically 15 minutes or less.

In another aspect, the present invention provides hydrophobic carbon fiber construction made according to the electrophoretic method of the present invention, in particular one having a highly uniform coating of a highly fluorinated polymer.

In another aspect, the present invention provides a hydrophobic carbon fiber construction coated with a monolayer of particles of a highly fluorinated polymer. In a further embodiment, the particles of highly fluorinated polymer may be sintered.

What has not been described in the art, and is provided by the present invention, is a method of manufacturing a hydrophobic gas diffusion layer for use in a fuel cell by electrophoretic deposition of a fluoropolymer.

In this application:

“monolayer” typically refers to a layer of particles on a surface that has a depth of not more than one particle over substantially all of the surface, and may optionally include a layer grown to a thicker depth than one particle if substantially all of the surface has first been covered with a layer of abutting particles having a depth of one particle; and

“highly fluorinated” means containing fluorine in an amount of 40 wt % or more, but typically 50 wt % or more, and more typically 60 wt % or more.

It is an advantage of the present invention to provide a quick and convenient method of manufacturing a hydrophobic gas diffusion layer having a uniform coating of a fluoropolymer.

### BRIEF DESCRIPTION OF THE DRAWING

FIG. 1 is an electron micrographs of a fluoropolymer-coated substrate according to the present invention at 11,600× magnification.

FIG. 2 is an electron micrographs of a fluoropolymer-coated substrate according to the present invention at 5,800× magnification.

FIG. 3 is an electron micrographs of a comparative fluoropolymer-coated substrate at 1,990× magnification.

FIG. 4 is an electron micrographs of a comparative fluoropolymer-coated substrate at 9,200× magnification.

FIG. 5 is an electron micrographs of a fluoropolymer-coated substrate according to the present invention at 3,500× magnification.

FIG. 6 is an electron micrographs of a fluoropolymer-coated substrate according to the present invention at 3,100× magnification.

FIG. 7 is a graph of data showing resistivity vs. compression for carbon papers treated according to the present invention (2 and 3) and a comparative untreated paper (1).

### DETAILED DESCRIPTION OF PREFERRED EMBODIMENTS

The present invention provides an electrophoretic method of making a hydrophobic carbon fiber construction such as a fuel cell gas diffusion layer. Briefly, the present method comprises the steps of: a) immersing a carbon fiber construction in an aqueous dispersion of a highly fluorinated polymer; b) contacting the dispersion with a counterelectrode; and c) electrophoretically depositing the highly fluorinated polymer onto the carbon fiber construction by applying electric current between the carbon fiber construction and the counterelectrode.

Fuel cells are electrochemical cells which produce usable electicity by the catalyzed combination of a fuel such as hydrogen and an oxidant such as oxygen. Typical fuel cells contain layers known as gas diffusion layers or diffuser/current collector layers adjacent to catalytically reactive sites. These layers must be electrically conductive yet must be able to allow the passage of reactant and product fluids. Typical gas difusion layers comprise porous carbon materials. In some fuel cell systems, it is advantageous to use a gas diffusion layer which is more hydrophobic than untreated carbon. The present invention concerns the manufacture of hydrophobic gas diffusion layers.

Any suitable carbon fiber construction may be used. Typically the carbon fiber construction is selected from woven and non-woven carbon fiber constructions. Carbon fiber constructions which may be useful in the practice of the present invention may include: Toray™ Carbon Paper, SpectraCarb™ Carbon Paper, AFN™ non-woven carbon cloth, Zoltek™ Carbon Cloth, and the like.

Any suitable electrodeposition equipment may be used, including a Hull Cell. Typically the carbon fiber construction is the anode and the counterelectrode is the cathode. A typical counterelectrode is mild steel plate. Any suitable source of electric current may be used.

Any suitable aqueous dispersion of highly fluorinated polymer may be used. The dispersion may be a colloidal suspension or a latex. Average particle size in the dispersion is typically less than 500 nm and more typically between 300 and 50 nm. The highly fluorinated polymer is typically a perfluorinated polymer, such as polytetrafluoroethylene (PTFE), fluorinated ethylene propylene (FEP), perfluoroalkyl acrylates, hexafluoropropylene copolymers, tetrafluoroethylene/hexafluoropropylene/vinylidene fluoride terpolymers, and the like.

The electric current applied between the carbon fiber construction and the counterelectrode is sufficient to deposit the desired amount of fluoropolymer. Typically, the electric current is applied at a voltage of at least 6 volts, more typically at least 15 volts, and most typically at least 30 volts. However it is an advantage of the present method that it can be performed using relatively low voltages of less than 100 volts and more typically less than 50 volts.

It is an advantage of the present method that it can be performed in a speedy manner and is therefore suitable for commercial production. Typically, the duration of the electrodeposition step is not more than 30 minutes, more typically not more than 15 minutes.

Typically the highly fluorinated polymer is deposited onto the carbon fiber construction in the amount of at least 0.1 weight percent per weight of carbon fiber construction, more typically at least 1 weight percent, more typically 1 to 10 weight percent, and most typically 1 to 5 weight percent. Higher levels of deposition from 5 to 30 weight percent or more may also be achieved.

Typically, the treated carbon fiber construction is subsequently rinsed and dried.

The treated carbon fiber construction may also be heated to sinter the fluoropolymer particles. Sintering temperatures depend on the fluoroplymer chosen, but are typically at least 150° C., more typically at least 250° C., and most typically at least 350° C. Sintering time is typically at least 10 minutes, more typically at least 20 minutes, and most typically at least 30 minutes. Additionally, coatings may be added including hydrophobic coatings such as fluoropolymer/carbon coatings.

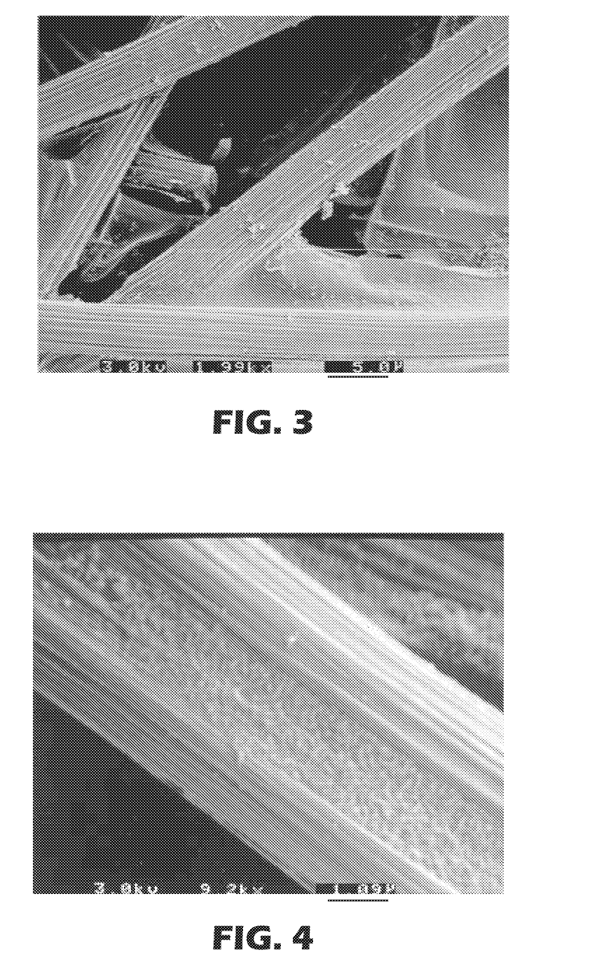

Fluropolymer coatings produced according to the method of the present invention are uniquely uniform. FIGS. 1, 2, 5 and 6 are micrographs of substrates coated according to the present invention. It can bee seen that the particles of fluoropolymer form a monolayer on the surface of the fibers. In contrast, the comparative fluoropolymer-coated substrates appearing in FIGS. 3 and 4 contain clumped fluoropolymer particles. FIG. 3 illustrates that fluoropolymer particles tend to concentrate at the intersections of fibers in the course of the comparative dipping and drying method. Large areas of many fibers are entirely uncoated. Without wishing to be bound by theory, it is believed that the method according to the present invention forces a uniform distribution of fluoropolymer because of the insulating nature of the coating.

This invention is useful in the manufacture of hydrophobic fuel cell gas diffusion layers.

Objects and advantages of this invention are further illustrated by the following examples, but the particular materials and amounts thereof recited in these examples, as well as other conditions and details, should not be construed to unduly limit this invention.

### EXAMPLES

Unless otherwise noted, all reagents were obtained or are available from Aldrich Chemical Co., Milwaukee, Wis., or may be synthesized by known methods.

### Examples 1 and 2C

In Example 1, Teflon® PTFE 30B colloidal suspension (DuPont Fluoroproducts, Wilmington, Del.) was electrodeposited on Toray™ Carbon Paper 060 (Toray International Inc., Tokyo, Japan). A 1 cm² piece of carbon paper was used as the anode of the electrolytic cell and a mild steel plate was used as the cathode. The PTFE suspension was diluted to 1% by weight with deionized water. A 6 volt potential was applied between the anode and cathode for 15 minutes to deposit the PTFE particles on the carbon paper. The sample was dried.

In Comparative Example 2C, Toray™ Carbon Paper 060 (Toray International Inc., Tokyo, Japan) was dipped in the same 1% Teflon® PTFE 30B colloidal suspension for 15 minutes and dried.

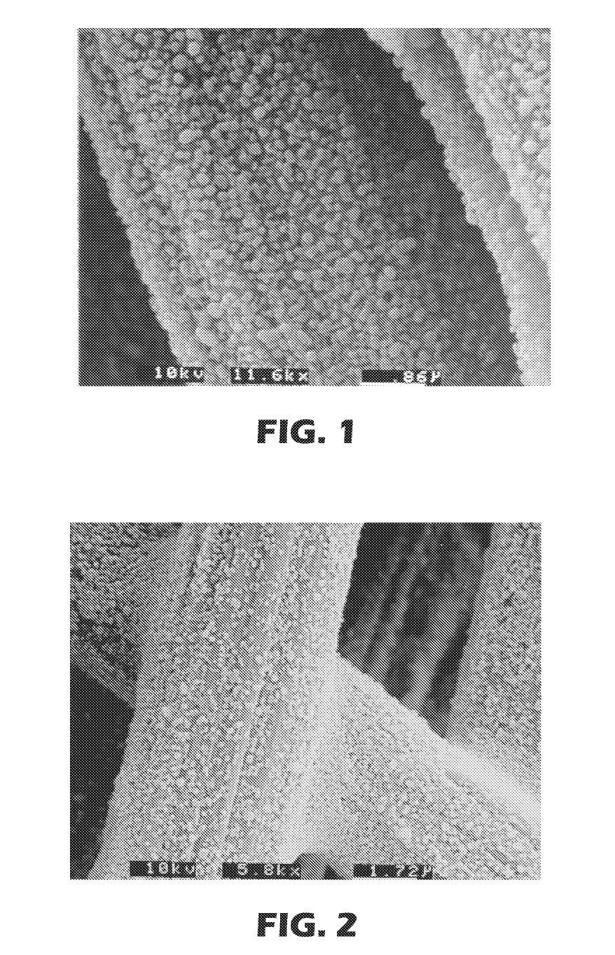

FIGS. 1 and 2 are electron micrographs of the coated product of Example 1. FIGS. 3 and 4 are electron micrographs of the coated product of Comparative Example 2C. These micrographs demonstrate the high degree of uniformity obtained by use of the method according to the present invention.

### Example 3 and 4

In Examples 3 and 4, Teflon® PTFE 30B colloidal suspension (DuPont Fluoroproducts, Wilmington, Del.) was diluted to 1% by weight with deionized water and poured into a Hull Cell. Toray™ Carbon Paper 060 (Toray International Inc., Tokyo, Japan) was fitted into the Hull Cell as the anode. The cathode was mild steel. The electrode distance was 40 mm. Nominal surface area of cathode was 33 cm² and anode was 28 cm². For Example 3, a 15 volt potential was applied between the anode and cathode for 15 minutes to deposit the PTFE particles on the carbon paper. For Example 4, a 30 volt potential was applied between the anode and cathode for 15 minutes to deposit the PTFE particles on the carbon paper. The carbon paper was removed and gently rinsed in DI water. The sample was dried in air for 1 hour, pumped down under vacuum and imaged under an electron microscope to observe the deposition progress.

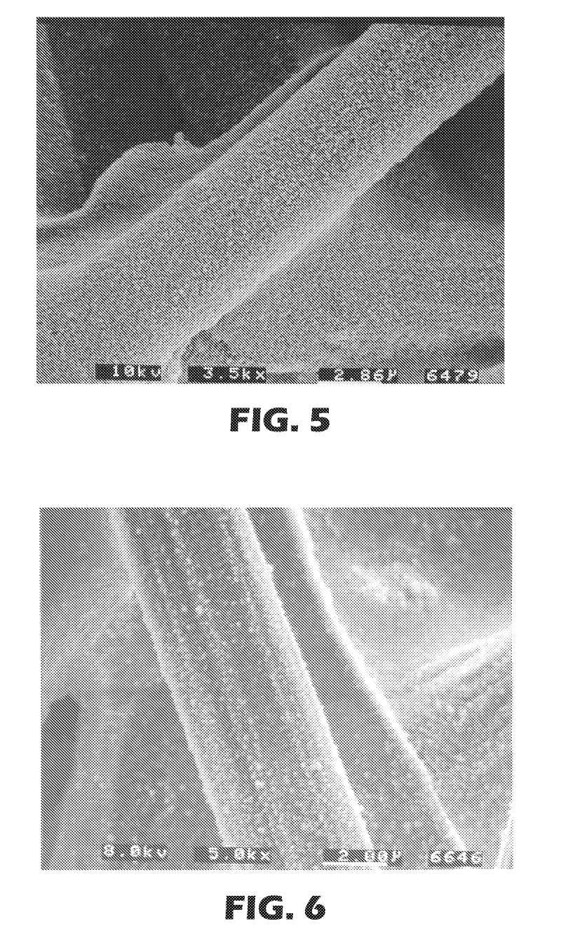

FIGS. 5 and 6 are electron micrographs of the coated products of Examples 3 and 4, respectively. The micrographs demonstrate that uniformity and density of the deposition increase with applied voltage.

Samples of the treated carbon papers according to Examples 3 and 4 were then sintered at 380° C. for 10 to 30 minutes and tested for plugging using a Gurley porosity measuring instrument (Model # 4110 Densometer and Model # 4320 Automatic Digital Timer, Gurley Precision Instrument, Troy N.Y.). An comparative untreated sample was tested also. The Gurley number for the untreated carbon paper was 7.4 seconds. The Gurley number for the treated paper of Example 4 was between 8.0 and 8.4 seconds. Thus, the paper was coated with minor and acceptable loss of porosity.

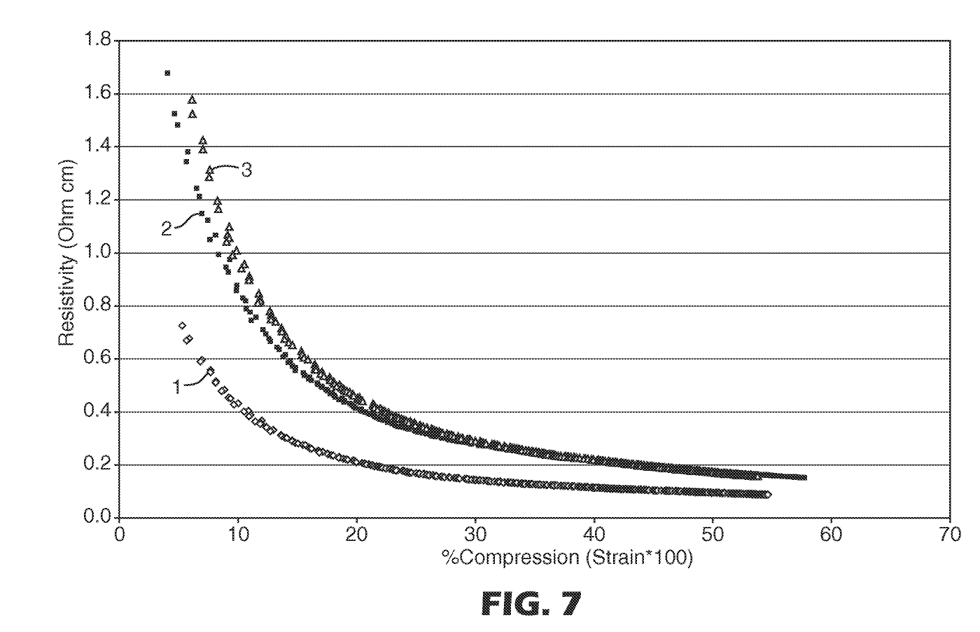

Resistivity of the treated and sintered carbon papers according to Examples 3 and 4 was tested using a Resistance/Compression Tester, comprising a press equipped to compress a sample between two electrically isolated platens so as to allow simultaneous measurement of compression and electrical resistivity at a given pressure. FIG. 7 demonstrates resistivity vs. compression data for carbon papers according to Example 3 (2), Example 4 (3) and a comparative untreated paper (1). It can be seen that the treatment according to the invention did not significantly compromise the electrical and physical properties of the carbon paper.

Advancing and receding dynamic contact angles to water were measured for samples according to Examples 1, 2C, 3 and 4 using deionized water and a Cahn DCA-322 Dynamic Contact Angle Analyzer (Thermo Cahn, Madison, Wis.). Three cycles were measured for each sample. The cycling is an indication of the durability of the hydrophobicity for each sample. The data is reported in Table I.

TABLE I

| | Deposition | Test | Water Advancing | Water Receding |
|---|---|---|---|---|
| Example | Voltage | Cycle No. | (degrees) | (degrees) |
| 1 | 6 | 1 | 169 | 69 |
| 1 | 6 | 2 | 114 | 65 |
| 1 | 6 | 3 | 109 | 63 |
| 3 | 15 | 1 | 170 | 97 |
| 3 | 15 | 2 | 162 | 115 |
| 3 | 15 | 3 | 162 | 113 |
| 4 | 30 | 1 | 180 | 121 |
| 4 | 30 | 2 | 161 | 130 |
| 4 | 30 | 3 | 137 | 126 |
| 2C | NA | 1 | 141 | 0 |
| 2C | NA | 2 | 125 | 0 |
| 2C | NA | 3 | 112 | 18 |

This data illustrates that the carbon paper tended to be increasingly more hydrophobic for samples treated at higher voltages. The dip-coated sample appeared hydrophobic at first but lost hydrophobicity after multiple cycling.

Various modifications and alterations of this invention will become apparent to those skilled in the art without departing from the scope and principles of this invention, and it should be understood that this invention is not to be unduly limited to the illustrative embodiments set forth hereinabove. All publications and patents are herein incorporated by reference to the same extent as if each individual publication or patent was specifically and individually indicated to be incorporated by reference.

We claim:

1. A method of making a hydrophobic carbon fiber construction coated with a monolayer of particles of a highly fluorinated polymer, said monolayer being a layer of particles on a surface that has a depth of not more than one particle over substantially all of the surface, comprising the steps of:
a) immersing a carbon fiber construction in an aqueous dispersion of a highly fluorinated polymer;
b) contacting said dispersion with a counterelectrode; and
c) electrophoretically depositing said highly fluorinated polymer on said carbon fiber construction by applying electric current between said carbon fiber construction and said counterelectrode.

2. The method according to claim 1 wherein said highly fluorinated polymer is selected from the group consisting of polytetrafluoroethylene (PTFE), fluorinated ethylene propylene (FEP), perfluoroalkyl acrylates, hexafluoropropylene copolymers, and tetrafluoroethylene/hexafluoropropylene/vinylidene fluoride terpolymers.

3. The method according to claim 1 wherein said highly fluorinated polymer is polytetrafluoroethylene (PTFE).

4. The method according to claim 1 wherein said carbon fiber construction is a woven carbon fiber construction.

5. The method according to claim 1 wherein said carbon fiber construction is a non-woven carbon fiber construction.

6. The method according to claim 1 wherein said step of electrophoretically depositing said highly fluorinated polymer has a duration of not more than 30 minutes.

7. The method according to claim 1 wherein said step of electrophoretically depositing said highly fluorinated polymer has a duration of not more than 15 minutes.

8. The method according to claim 1 wherein said electric current is applied at a voltage of between 6 and 100 volts.

9. The method according to claim 1 additionally comprising the step of: d) sintering said highly fluorinated polymer by heating said carbon fiber construction.

10. The hydrophobic carbon fiber construction made according to the method of claim 1.

11. The hydrophobic carbon fiber construction made according to the method of claim 9.

12. A hydrophobic carbon fiber construction coated with a monolayer of particles of a highly fluorinated polymer, said monolayer being a layer of particles on a surface that has a depth of not more than one particle over substantially all of the surface.

13. The hydrophobic carbon fiber construction according to claim 12 wherein said highly fluorinated polymer is selected from the group consisting of polytetrafluoroethylene (PTFE), fluorinated ethylene propylene (FEP), perfluoroalkyl acrylates, hexafluoropropylene copolymers, and tetrafluoroethylene/hexafluoropropylene/vinylidene fluoride terpolymers.

14. The hydrophobic carbon fiber construction according to claim 12 wherein said highly fluorinated polymer is polytetrafluoroethylene (PTFE).

15. The hydrophobic carbon fiber construction according to claim 12 wherein said carbon fiber construction is a woven carbon fiber construction.

16. The hydrophobic carbon fiber construction according to claim 12 wherein said carbon fiber construction is a non-woven carbon fiber construction.

17. The hydrophobic carbon fiber construction according to claim 12 wherein said particles of a highly fluorinated polymer are sintered.
